(19) United States
(12) Patent Application Publication
(10) Pub. No.: US 2018/0364514 A1
(43) Pub. Date: Dec. 20, 2018

(54) DISPLAY DEVICE

(71) Applicant: SHARP KABUSHIKI KAISHA, Sakai City, Osaka (JP)

(72) Inventor: HOKSHING LIU, Sakai City (JP)

(73) Assignee: SHARP KABUSHIKI KAISHA, Sakai City, Osaka (JP)

(21) Appl. No.: 15/747,054

(22) PCT Filed: Aug. 24, 2016
(86) PCT No.: PCT/JP2016/074590

§ 371 Date: Jan. 23, 2018

(30) Foreign Application Priority Data
Aug. 26, 2015 (JP) 2015-166556

(51) Int. Cl. G02F 1/1345; G02F 1/1333; G09G 3/36

(52) U.S. Cl. CPC G02F 1/13452; G09G 3/3674; G02F 1/133308

(57) ABSTRACT

A display device according to one aspect of the present invention includes: a display panel configured to include a plurality of pixels and a pair of substrates facing each other; driver elements configured to drive the plurality of pixels; an external circuit board configured to control the driver elements; and a plurality of driver circuit boards on which the driver elements are mounted and of which one end is connected to the display panel. Each of the plurality of driver circuit boards includes a grounding wire for setting a potential on a display surface side of the display panel to a ground potential around the driver elements, and one end is connected to both of the pair of substrates.

### TECHNICAL FIELD

An aspect of the present invention relates to a display device.

Priority is claimed on Japanese Patent Application No. 2015-166556, filed Aug. 26, 2015, the content of which is incorporated herein by reference.

### BACKGROUND ART

In general, a liquid crystal display device (a display device) includes a liquid crystal panel, a driver IC as a drive circuit that drives the liquid crystal panel in accordance with a control signal, and a driver circuit board on which the driver IC is mounted. For example, when a protective laminate film attached to a front surface of a display panel is peeled off at the time of assembly of a television using a liquid crystal display device, static electricity is generated. When this static electricity is transmitted to a driver IC connected to a liquid crystal panel, circuit breakdown occurs and normal display is not possible.

A technique of preventing electrostatic discharge failure of a driver circuit is disclosed, for example, in Patent Document 1. Patent Document 1 describes an IPS liquid crystal panel and a flexible cable on which a driver IC is mounted. The flexible cable includes a signal wire that transmits a driving signal of the liquid crystal panel, a grounding wire that includes a ground terminal connected to a transparent potential film that discharges static electricity of the liquid crystal panel, and a sheet-shaped body portion in which the signal wire and the grounding wire are formed.

### PRIOR ART DOCUMENTS

### Patent Documents

### [Patent Document 1]

Japanese Unexamined Patent Application, First Publication No. 2014-206604

### SUMMARY OF THE INVENTION

### Problem to Be Solved by the Invention

In the IPS liquid crystal panel described in Patent Document 1, since it is necessary to protect the driver IC from electrostatic discharge, the transparent potential film is disposed between a first polarizing film and a first glass substrate and the transparent potential film is grounded to discharge static electricity. However, such an electrostatic discharge (ESD) measure has a problem in cost and the number of steps in the process.

One aspect of the invention is made in consideration of the above-mentioned problem of the background art and an object thereof is to provide a display device in which a drive circuit can be satisfactorily protected from electrostatic discharge at a low cost and with a simple structure.

### Means for Solving the Problems

A display device according to one aspect of the present invention includes: a display panel configured to include a plurality of pixels and a pair of substrates facing each other; driver elements configured to drive the plurality of pixels; an external circuit board configured to control the driver elements; and a plurality of driver circuit hoards on which the driver elements are mounted and of which one end is connected to the display panel, Wherein each of the plurality of driver circuit boards includes a grounding wire for setting a potential on a display surface side of the display panel to a ground potential around the driver elements and is connected to each of the pair of substrates.

In addition, in the display device according to one aspect of the present invention, the configuration may be that the display device further includes: a driver driving common wire configured to electrically connect the driver elements of the plurality of driver circuit boards adjacent to each other and to supply a driving signal for the driver elements from the external circuit board to the driver elements; and a ground potential common wire configured to set the plurality of driver circuit boards adjacent to each other to a ground potential, wherein the ground potential common wire includes the grounding wire.

In addition, in the display device according to one aspect of the present invention, the configuration may be that the ground potential common wire is grounded via the external circuit hoard.

In addition, in the display device according to one aspect of the present invention, the configuration may be that a plurality of gate driver circuit hoards for driving gate lines are connected to one side of the display panel, wherein a plurality of source driver circuit hoards for driving source lines are connected to another side adjacent to the one side, and wherein the driver driving common wire and the ground potential common wire are formed on the plurality of gate driver circuit hoards and at least one of the plurality of source driver circuit boards connected to the external circuit board.

In addition, in the display device according to one aspect of the present invention, the configuration may be that the plurality of driver circuit hoards are connected to a surface of one substrate of the pair of substrates of the display panel on which wires and terminals are formed and a surface of the other substrate of the pair of substrates which is opposite to the one substrate.

### Effect of the Invention

According to the aspect of the invention, it is possible to provide a display device in which a drive circuit can be satisfactorily protected from electrostatic discharge at a low cost and with a simple structure.

### BRIEF DESCRIPTION OF THE DRAWINGS

FIG. 1 is a diagram schematically illustrating a configuration of a liquid crystal display device according to an embodiment of the invention.

FIG. 2 is a diagram schematically illustrating a configuration near a TFT substrate and driver circuit boards.

FIG. 3 is a cross-sectional view taken along line A-A′ in FIG. 1.

FIG. 4 is a cross-sectional view taken along line B-B′ in FIG. 1.

FIG. 5 is a plan view illustrating a source driver circuit board.

FIG. 6 is a plan view illustrating a gate driver circuit board.

FIG. 7 is an exploded view illustrating a configuration near a driver circuit board of a liquid crystal display device.

FIG. 8 is a diagram illustrating a liquid crystal display device according to a first embodiment.

FIG. 9 is a diagram illustrating a liquid crystal display device according to a second embodiment.

### EMBODIMENTS FOR CARRYING OUT THE INVENTION

Hereinafter, a display device according to an embodiment of the invention will be described.

In the drawings which will be described below, a dimensional scale may vary for each element so that the elements can be easily understood,

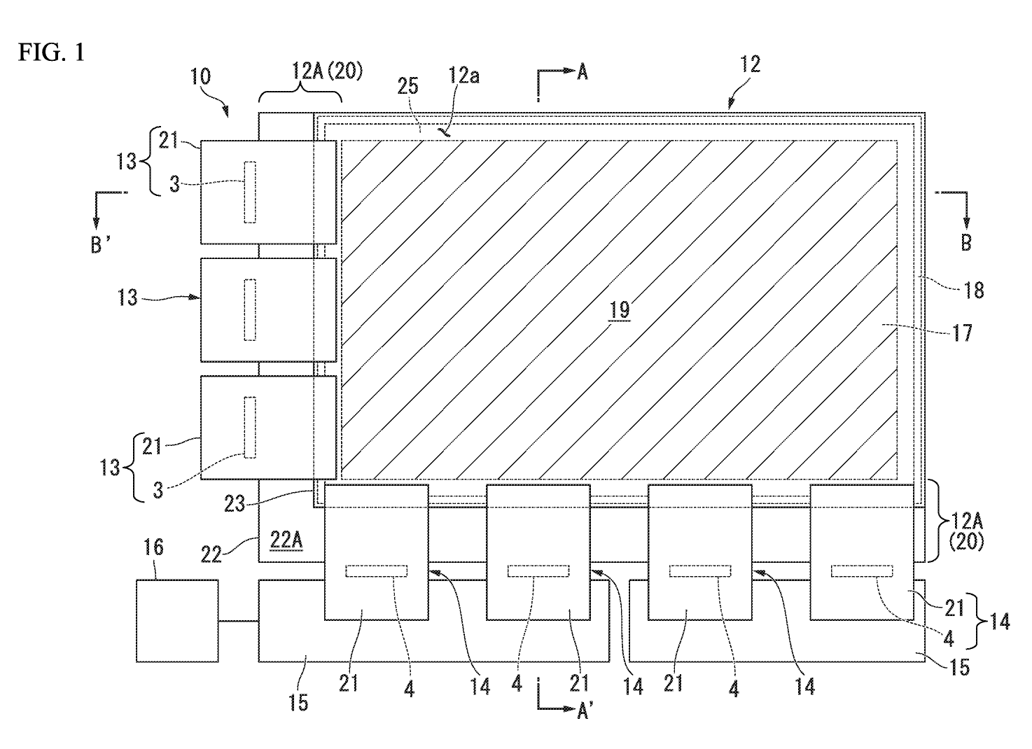

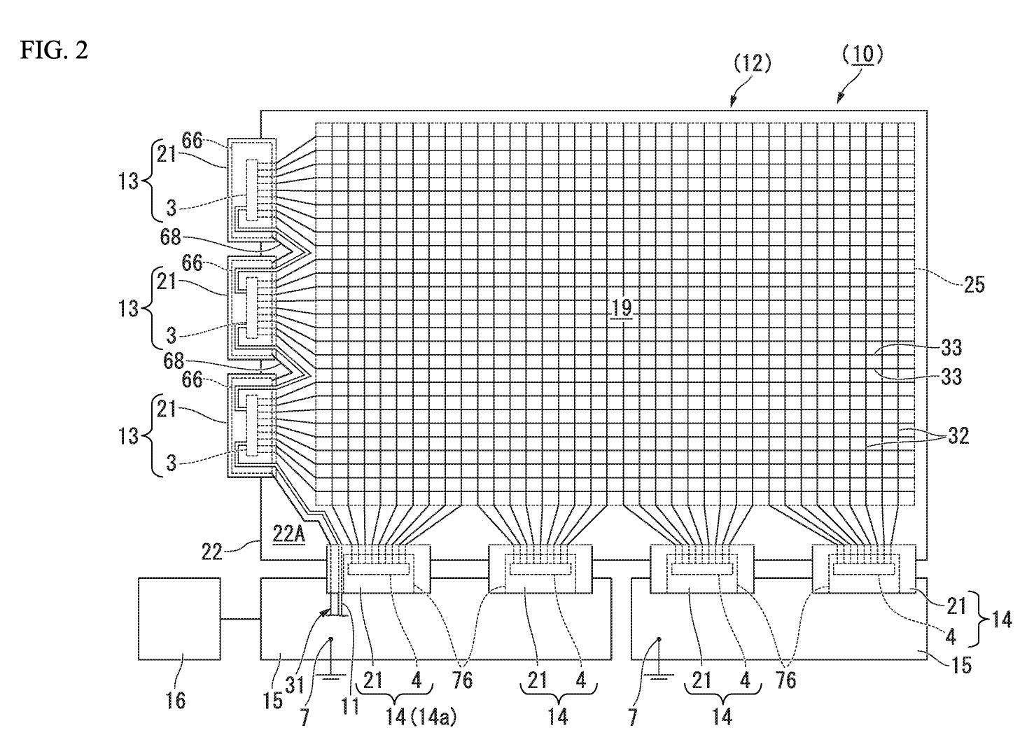

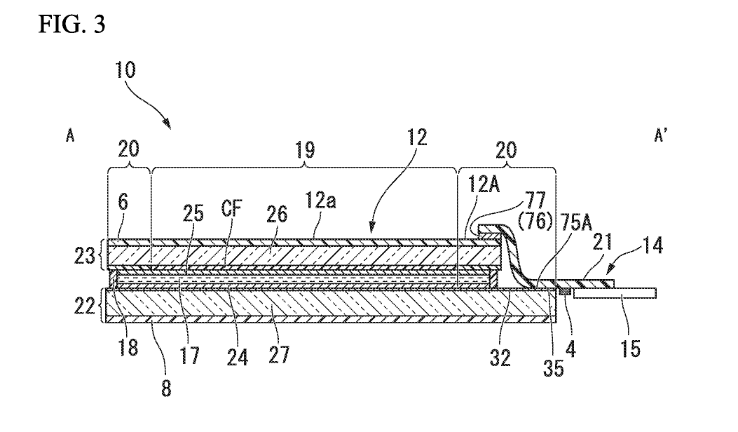

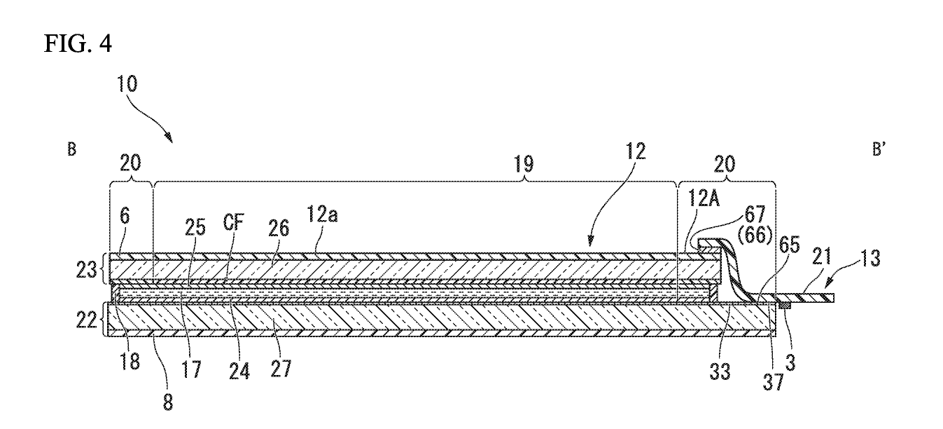

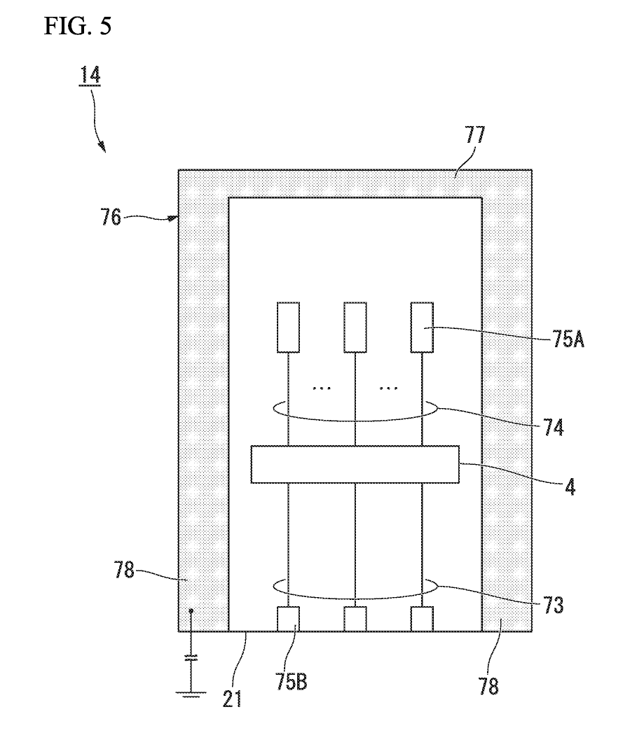

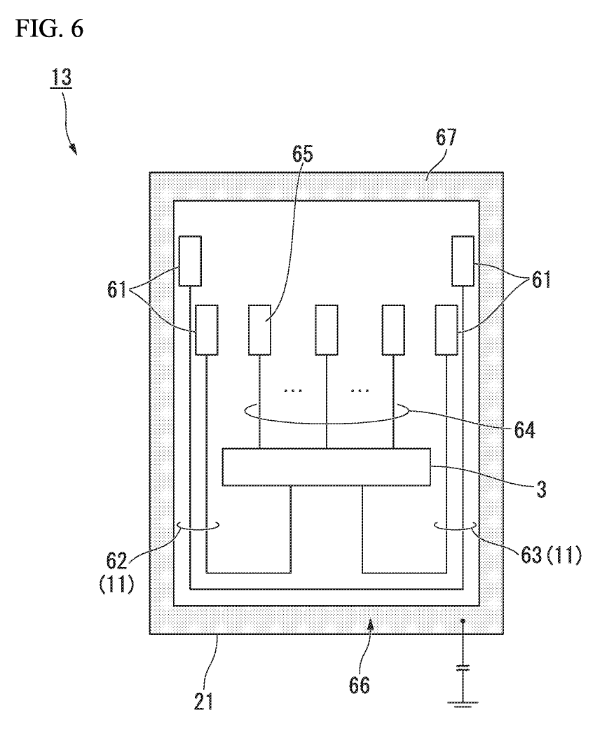

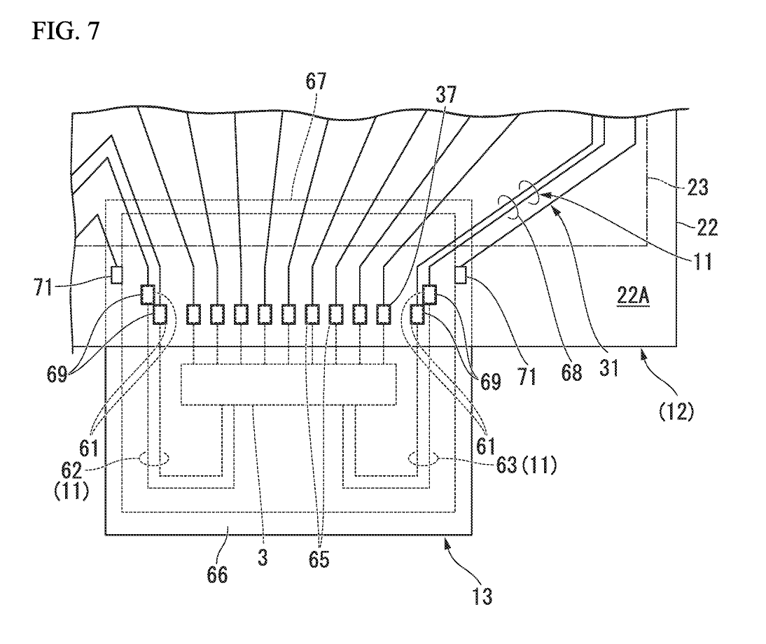

FIG. 1 is a diagram schematically illustrating a configuration of a liquid crystal display device according to an embodiment of the invention. FIG. 2 is a diagram schematically illustrating a configuration near a TFT substrate and driver circuit hoards. FIG. 3 is a cross-sectional view taken along line A-A′ in FIG. 1. FIG. 4 is a cross-sectional view taken along line B-B′ in FIG. 1, FIG. 5 is a plan view illustrating a source driver circuit board. FIG. 6 is a plan view illustrating a gate driver circuit hoard. FIG. 7 is an exploded view illustrating a configuration near a driver circuit board of a liquid crystal display device.

As illustrated in FIGS. 1 and 2, a liquid crystal display device (a display device) 10 according to this embodiment mainly includes a display panel 12, a plurality of gate driver circuit hoards (driver circuit hoards) 13, a plurality of source driver circuit boards (driver circuit boards) 14, an external circuit board 15, and a controller 16. The display panel 12 according to this embodiment is a gate board-less liquid crystal display device 10 in which an external circuit board is not provided on the gate driver circuit hoards 13 side.

A pixel formation area in a pair of substrates 22 and 23 included in the display panel 12 is defined as a display area 19 in which an image is displayed. Three gate driver circuit boards 13 and four source driver circuit hoards 14 are attached to an outer peripheral edge portion 22A of a TFT substrate 22 other than an overlap area with a counter substrate 23.

Among driver ICs 3 and 4 for driving the liquid crystal display device 10, a driver IC (a driver element) 3 is mounted on each gate driver circuit board 13, and a driver IC (a driver element) 4 is mounted on each source driver circuit board 14.

The number of driver circuit boards 13 and 14 is appropriately set depending on the size of the display panel 12 or the like. In this embodiment, an L-shaped area along two neighboring sides of the TFT substrate 22 is defined as the outer peripheral edge portion 22A, but the invention is not limited thereto.

The configuration in which the driver circuit boards 13 and 14 are provided on two neighboring sides of the TFT substrate 22 as in this embodiment can be suitably employed when the size of the liquid crystal display device 10 is less than 32 inches.

In this embodiment, two source driver circuit boards 14 are connected to one external circuit board 15 as one group, but four source driver circuit boards 14 may be connected to one external circuit board 15.

As illustrated in FIG. 2, in an outer peripheral edge portion 22A of the display panel 12, a gate driver driving common wire (a driver driving common wire) 11 that supplies a signal or a power input commonly to the gate driver circuit boards 13 and a ground potential common wire 31 that sets the potential of the display panel 12 side to the ground potential are continuously formed in an arrangement range of the plurality of gate driver circuit boards 13.

The gate driver driving common wire 11 is supplied with a signal or driving power supplied commonly to the gate driver circuit boards 13 from the external circuit board 15.

The ground potential common wire 31 is provided commonly in the plurality of gate driver circuit boards 13 and is electrically connected to a ground conductor 7 which is disposed on the external circuit board 15 via a single source driver circuit board 14 to be set to the ground potential.

The liquid crystal display device 10 is configured to include the display panel 12, the plurality of gate driver circuit boards 13, the plurality of source driver circuit boards 14, the external circuit board 15, and the controller 16.

As illustrated in FIG. 3, one end of each source driver circuit board 14 is connected to the external circuit board 15, and the other end thereof is disposed to be placed on a display surface 12a of the display panel 12 and is connected to the display surface 12a in a pressure-bonded state. Here, the display surface 12a of the display panel 12 is a surface of the display panel 12 closest to a viewer and is an outer surface of a polarizing film 6 opposite to a liquid crystal layer 17 in this embodiment.

As illustrated in FIG. 4, one end of each gate driver circuit board 13 is disposed to be placed on the display surface 12a of the display panel 12 and is connected to the display surface 12a in a pressure-bonded state.

In this embodiment, intermediate portions of the gate driver circuit board 13 and the source driver circuit board 14 are pressed and bonded to one surface of the TFT substrate 22 (the surface on the counter substrate 23 side). Specifically, the driver circuit boards are pressed and bonded to predetermined positions of the outer peripheral edge portion 22A on one surface of the TFT substrate 22.

In this way, the gate driver circuit boards 13 and the source driver circuit hoards 14 are disposed on the outer peripheral edge portion 12A of the display panel 12 and are connected to both the TFT substrate 22 and the counter substrate 23, Here, the connection of the gate driver circuit boards 13 and the source driver circuit boards 14 to the display panel 12 is carried out using an anisotropic conductive material which is not illustrated.

As illustrated in FIGS. 1 and 2, the liquid crystal display device 10 according to this embodiment is configured to discharge static electricity generated on the display surface 12a side of the display panel 12 to the ground by connecting the display surface 12a of the display panel 12 to the ground conductor 7 of each external circuit board 15 via the gate driver circuit boards 13 and the source driver circuit boards 14.

Elements of the liquid crystal display device will be described below in detail.

As illustrated in FIGS. 2 and 3, the display panel 12 includes the TFT substrate 22, the counter substrate 23, the liquid crystal layer 17, and a sealing member 18. The TFT substrate 22 in which a plurality of pixel electrodes (not illustrated) are formed on one surface thereof and the counter substrate 23 in which a common electrode 25 is formed on one surface thereof are disposed to face the surfaces on which transparent electrodes are formed and are disposed with the liquid crystal layer 17 interposed therebetween. The sealing member 18 seals the liquid crystal layer 17 between the TFT substrate 22 and the counter substrate 23.

In the display panel 12, an area in which the pixel electrodes and the common electrode 25 (FIG. 1) are formed in the TFT substrate 22 and the counter substrate 23 is defined as a display area 19 in which an image is displayed.

A plurality of pixels that are arranged in a matrix shape are formed in the display area 19.

The TFT substrate 22 includes a glass substrate 27 as a transparent insulating substrate. As illustrated in FIG. 2, a plurality of source lines 32 extending in parallel, a plurality of gate lines 33 extending to be perpendicular to the source lines, and an element structure including a pixel electrode layer 24 and the like are formed on the liquid crystal layer 17 side of the glass substrate 27. Wire groups including the gate lines 33 and the source lines 32 are formed in a lattice shape as a whole. A pixel is formed in each latticed area.

The counter substrate 23 includes a glass substrate 26 as a transparent insulating substrate. A color filter layer CF, the common electrode 25, and the like are formed on the liquid crystal layer 17 side of the glass substrate 26.

As illustrated in FIG. 2, a polarizing film 6 and a polarizing film 8 of which light-transmission axes are different from each other by 90° are disposed on outer surfaces of the substrates 22 and 23 which are surfaces of the glass substrates 26 and 27 opposite to the liquid crystal layer 17.

As will be described later, a thin-film transistor (TFT) which is a switching element and a pixel electrode (not illustrated) which is connected thereto are formed in each pixel.

The TFT is connected to the corresponding source line 32 and the corresponding gate line 33.

A plurality of gate driver circuit boards 13 and a plurality of source driver circuit boards 14 are mounted on the display panel 12 along the outer peripheral edge portion 12A thereof. Specifically, the gate driver circuit hoards 13 and the source driver circuit boards 14 are attached along two sides of the polarizing film 6 located on the display surface 12a side.

The outer peripheral edge portion 12A of the display panel 12 is a non-display area 20 outside the display area 19 on the display surface 12a side opposite to the liquid crystal layer 17. The gate driver circuit boards 13 and the source driver circuit boards 14 are connected to an outer peripheral edge portion 23A of the counter substrate 23 and the outer peripheral edge portion 22A of the TFT substrate 22 in the non-display area 20, respectively.

The outer peripheral edge portion 22A of the TFT substrate 22 is a portion other than an overlap area with the counter substrate 23 and is an area protruding outward from the counter substrate 23 in a plan view.

A plurality of FPC connection terminals for connection to the gate driver circuit boards 13 and the source driver circuit boards 14 are provided in the outer peripheral edge portion 23A of the counter substrate 23 on the display surface 12a side.

Each of the gate driver circuit boards 13 and the source driver circuit boards 14 includes a gate driver IC 3 or a source driver IC 4 for driving a plurality of pixels in the display panel 12. As described above, each gate driver circuit board 13 includes the gate driver IC 3 and each source driver circuit board 14 includes the source driver IC 4,

Each of the gate driver circuit boards 13 and the source driver circuit boards 14 has a rectangular shape in a plan view and is referred to as a tape automated bonding (TAB) board.

Each of the gate driver circuit boards 13 and the source driver circuit boards 14 includes a flexible film 21 which is made of an electrical insulating material such as a polyimide resin or a polyester resin and the gate driver IC 3 or the source driver IC 4 is mounted on the flexible film 21. Various terminals or wires which will be described later or the like are formed on the flexible film 21.

The gate driver IC 3 of each gate driver circuit board 13 is a circuit that drives the gate lines 33 in the display area 19. The gate driver IC 3 is connected to the gate lines 33 in the display area 19 via output signal wires 64 which will be described later.

The source driver IC 4 of each source driver circuit board 14 is a circuit that drives the source lines 32 in the display area 19. The source driver IC 4 is connected to the source lines 32 in the display area 19 via output signal wires 74 which will be described later.

In each source driver circuit board 14, the external circuit board 15 is connected to an end opposite to the display panel 12. In this embodiment, two source driver circuit boards 14 are connected to one external circuit board 1.5, but the invention is not limited to this configuration. All the source driver circuit boards 14 may be connected to one external circuit board 15.

The external circuit board 15 is connected to the display panel 12 via the source driver circuit boards 14. The external circuit board 15 supplies control signals for controlling the gate driver ICs 3 and the source driver ICs 4 which are supplied from the controller 16 or a driving power to the source driver circuit boards 14 and the gate driver circuit boards 13.

In this embodiment, grounding wires 76 of all the source driver circuit boards 14 disposed in the display panel 12 are set to the ground potential. A specific configuration can be appropriately set and, for example, as illustrated in FIG. 2, a ground conductor 7 may be provided in each external circuit board 15. In this case, the grounding wires 76 and the ground conductors 7 of two source driver circuit boards 14, 14 connected to each external circuit board 15 may be electrically connected to each other via connecting wires which are not illustrated.

Alternatively, a ground conductor 7 may be disposed in only one of a plurality of external circuit boards 15 which are mounted on the display panel 12. The grounding wires 76 of four source driver circuit boards 14 may be connected to each other via connecting wires formed on the TFT substrate 22 and may be electrically connected to the ground conductor 7 by forming the ground potential common wires on the source driver circuit boards. A configuration other than that described above may be employed.

### (Source Driver Circuit Board)

Details of each source driver circuit board will be described below.

As illustrated in FIGS. 3 and 5, each source driver circuit board 14 includes a source driver IC 4, input signal wires 73, output signal wires 74, electrode terminals 75A and 75B, and a grounding wire 76 on a flexible film 21. The grounding wire 76 includes a connecting portion 77 which is used to connect the source driver circuit board 14 to the counter substrate 23 of the display panel 12.

As illustrated in FIG. 5, the input signal wires 73 supply an input signal from the external circuit board 15 to the source driver IC 4. The output signal wires 74 supply an output signal from the source driver IC 4 to the TFT substrate 22 side and supply the output signal from the source driver IC 4 to the source lines 32 via the electrode terminals 75A which are electrically connected to pressure-contact terminals 35 formed at ends of the source lines 32 on the TFT substrate 22.

The grounding wire 76 is formed on three sides of the flexible film 21 and a portion along one side of the display panel 12 side is the connecting portion 77 which is connected to the display panel 12.

The source driver circuit board 14 is connected to the external circuit board 15 via the electrode terminals 75B on the source driver circuit board 14 side and connecting terminals, which are not illustrated, on the external circuit board 15 side. The grounding wire 76 is electrically connected to the ground conductor 7 which is disposed on the external circuit board 15 via a pair of connecting portions 78 disposed at ends thereof, connecting terminals which are not illustrated on the external circuit board 15 side, and the like.

### (Gate Driver Circuit Board)

Details of each gate driver circuit board will be described below.

In the gate board-less liquid crystal display device 10 according to this embodiment, a so-called signal transmission system in which a signal input to one gate driver circuit board 13 is sequentially transmitted to the neighboring gate driver circuit board 13 is employed.

As illustrated in FIGS. 4 and 6, each gate driver circuit board 13 includes a gate driver IC 3, output signal wires 64, electrode terminals 65, a grounding wire 66, a part of the gate driver driving common wire 11, and a part of the ground potential common wire 31 on the flexible film 21.

The grounding wire 66 includes a connecting portion 67 which is used to connect the gate driver circuit board 13 to the counter substrate 23 of the display panel 12.

The output signal wires 64 are connected to the gate lines 33 via the electrode terminals 65 connected to end portions thereof and electrode terminals 37 formed on the TFT substrate 22 and supply an output signal from the gate driver IC 3 to the gate lines 33.

The grounding wire 66 is formed on four sides of the flexible film 21 and surrounds the gate driver IC 3 in the periphery of the flexible film 21. A portion of the grounding wire 66 along one side of the flexible film 21 on the display panel 12 side is the connecting portion 67.

As illustrated in FIG. 2, the grounding wires 66 disposed on the gate driver circuit boards 13 are connected to the connecting wires 68 on the TFT substrate 22 side. The connecting wires 68 are formed in connection areas between a plurality of gate driver circuit boards 13 on the TFT substrate 22, and the grounding wires 66 and the connecting wires 68 are electrically connected to each other at the same time at which the gate driver circuit boards 13 are mounted on the TFT substrate 22 (FIG. 7). At this time, the electrical connection between the grounding wires 66 and the connecting wires 68 may be achieved by pressing and bonding the connecting portions 67 to the electrode terminals 71 disposed on the TFT substrate 22 side.

The ground potential common wire 31 according to an aspect of the invention is constituted by the grounding wires 66 and the connecting wires 68.

The ground potential common wire 31 is formed in a single layer or multiple layers with a thickness of 50 nm or more, a line width of several μm to several mm, and a resistance of 0.1Ω/□ to several hundreds of Ω/□ out of a material such as ITO, Ta, Ti, Mo, Cu, Au, Al, or Ag paste.

As illustrated in FIG. 2, the ground potential common wire 31 is connected to the ground conductor 7 disposed on the external circuit board 15 via the source driver circuit board 14 located on the gate driver circuit boards 13 side and is set, to the ground potential. The ground potential common wire 31 in this embodiment is disposed to be parallel to the gate driver driving common wire 11.

The gate driver driving common wire 11 serves to electrically connect the neighboring gate driver circuit boards 13 to each other and to supply driving signals for the gate driver ICs 3 from the external circuit board 15 to the gate driver ICs 3. The source driver circuit board 14a (FIG. 2) on the gate driver circuit board 13 side and a plurality of gate driver circuit boards 13 are connected in series by the gate driver driving common wire 11. A display control signal input via. the source driver circuit hoard 14a is sequentially transmitted to the neighboring gate driver circuit boards 13 via the gate driver driving common wire 11 in a relay manner.

Examples of the gate driver driving common wire 11 include a clock signal wire and a start pulse signal wire in addition to a gate driver driving power supply wire.

As illustrated in FIG. 7, the gate driver driving common wire 11 is constituted by driving signal input wires 63, driving signal output wires 62, and electrode terminals 61 which arc disposed on the gate driver circuit boards 13, and connecting wires 68 and electrode terminals 69 which are disposed on the TFT substrate 22.

The gate driver driving common wire 11 is formed in a single layer or multiple layers with a thickness of 50 nm or more, a line width of several μm to several mm, and a resistance of 0.1Ω/□ to several hundreds of Ω/□ out of a material such as ITO, Ta, Ti, Mo, Cu, Au, Al, or Ag paste.

As illustrated in FIG. 2, the connecting wires 68 constituting the gate driver driving common wire 11 have a pattern drawn around portions in which the gate driver circuit boards 13 are connected on the TFT substrate 22 and are formed in the outer peripheral edge portion 22A. The connecting wires 68 are formed of the same film as the gate lines 33 and are covered with a stacked insulating film in which a gate insulating film and an interlayer insulating film are stacked.

At both ends of each connecting wire 68 located at an edge of the TFT substrate 22, the electrode terminals 69 for connection to the driving signal input wires 63 and the driving signal output wires 62 on the gate driver circuit boards 13 side are provided.

Although not illustrated in the drawings, the gate lines 33, the source lines 32, and auxiliary capacitor wires in the display area 19 extend to the outer peripheral edge portion 22A of the TFT substrate 22. At drawn tips of various wires located at the edges of the TFT substrate 22, terminals (not illustrated) for connection to the gate driver circuit boards 13 or the source driver circuit boards 14 are arranged along the edges of the TFT substrate 22.

The liquid crystal display device 10 according to this embodiment is configured as described above.

At, the time of assembly of the liquid crystal display device 10, in the related art, static electricity (peeling charge) is likely to be generated by peeling off the protective laminate film covering the display surface 12a of the display panel 12. The static electricity may be transmitted to the driver circuit boards connected to the display panel 12 and the driver ICs may break down to prevent normal display. When static electricity is generated on the display surface 12a, dust floating in the ambient air is adsorbed on the display surface and contaminates the display surface 12a. When static electricity is accumulated on the display surface 12a, there is a problem in that internal TFT drive circuits may be affected.

In this embodiment, the grounding wires 66 and 76 which are electrically insulated from the driver ICs 3 and 4 are formed in the gate driver circuit boards 13 and the source driver circuit boards 14, and the gate driver circuit boards 13 and the source driver circuit boards 14 are mounted on the outer peripheral edge portion of the display panel 12. As described above, the gate driver circuit boards 13 and the source driver circuit boards 14 are connected to the counter substrate 23 in addition to the TFT substrate 22, and end portions thereof (the grounding wires 66 and 76) are pressed and bonded to the display surface 12a of the display panel 12 to be placed thereon.

Accordingly, static electricity generated on the display surface 12a of the display panel 12 is transmitted to the external circuit board 15 via the driver circuit boards 13 and 14 (the grounding wires 66 and 76) and is discharged from the ground conductor 7. Specifically, static electricity transmitted from the display surface 12a to the source driver circuit boards 14 is discharged from the external circuit board 15 via the grounding wires 76. On the other hand, static electricity transmitted to the gate driver circuit boards 13 is transmitted to the TFT substrate 22 via the connecting wires 68 connected to the grounding wires 66 and is discharged from the external circuit board 15 via the source driver circuit board 14a located closest to the gate driver circuit boards 13.

According to this embodiment, by providing the grounding wires 66 and 76 in the driver circuit boards 13 and 14 and electrically connecting the display surface 12a of the display panel 12 to the ground conductor 7 of the external circuit board 15, it is possible to effectively remove static electricity charged on the display surface 12a.

In this embodiment, since the grounding wires 66 and 76 are formed to surround the driver ICs 3 and 4 and the grounding wires 66 and 76 are insulated from the driver ICs 3 and 4, it is possible to prevent electrostatic discharge failure of the driver ICs 3 and 4.

Since the ground potential common wire 31 including the grounding wires 66 and 76 can be formed at the same time at which various wires are formed on the driver circuit boards 13 and 14 and the TFT substrate 22, it is possible to form the ground potential common wire without an increase in the number of steps in the process. Accordingly, it is possible to provide a liquid crystal display device 10 that can satisfactorily protect drive circuits from electrostatic discharge failure at a low cost and with a simple structure. A gate board-less display device has been described above in the embodiment, but the invention is not limited thereto.

### First Embodiment

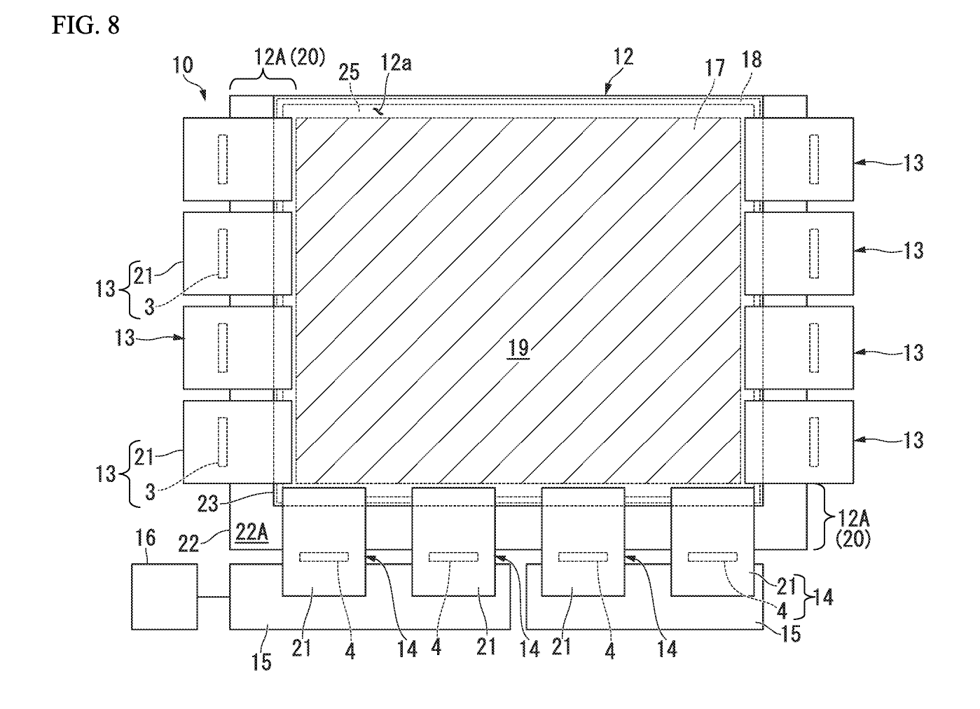

FIG. 8 is a diagram illustrating a liquid crystal display device according to a first embodiment.

As illustrated in FIG. 8, in the liquid crystal display device according to the first embodiment, a plurality of gate driver circuit boards 13 are mounted on both sides of the TFT substrate 22. Here, four gate driver circuit boards 13 are provided on each side. When the size of the liquid crystal display device is equal to or greater than 32 inches, a greater driving capability is necessary and it is thus preferable that the number of gate driver circuit boards 13 mounted increase.

### Second Embodiment

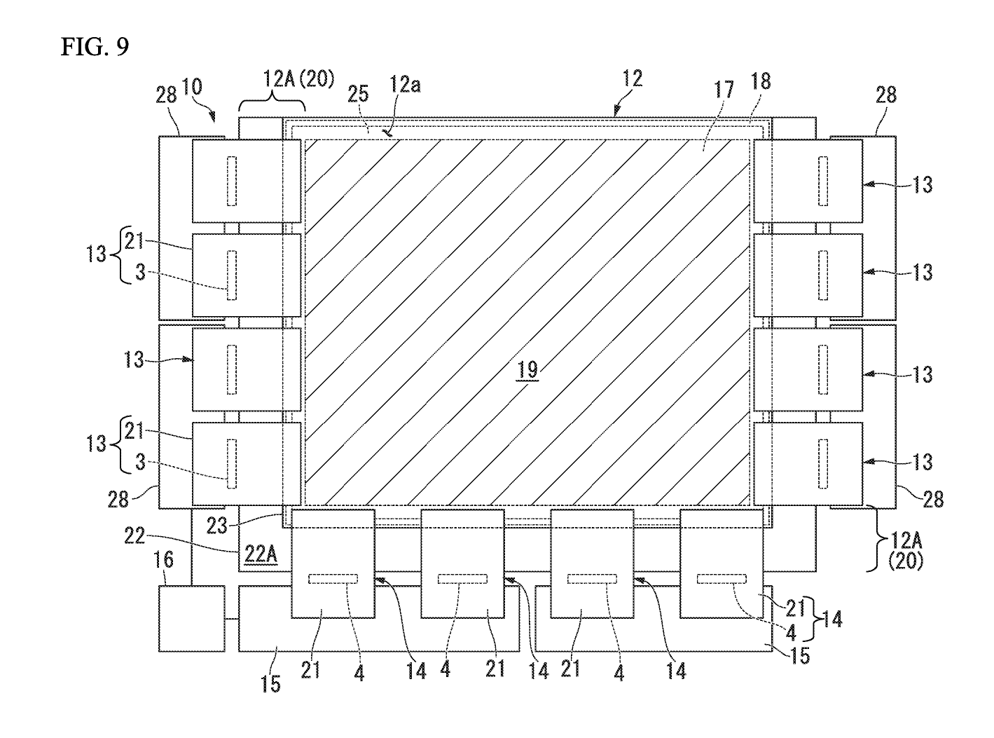

FIG. 9 is a diagram illustrating a liquid crystal display device according to a second embodiment.

As illustrated in FIG. 9, the invention can be applied to a configuration in which an external circuit board 28 common to a plurality of gate driver circuit boards 13 is further provided. In the second embodiment, one external circuit board 28 is provided for every four gate driver circuit boards 13, and one external circuit board 28 is disposed on each side of the TFT substrate 22. In order to reduce rounding of wires, it is preferable that a ground conductor be provided in each external circuit board 28.

While exemplary embodiments of the invention have been described above with reference to the accompanying drawings, the invention is not limited to the embodiments. Various modifications or corrections not departing from the technical concept described in the appended claims will be obvious to those skilled in the art, and it will be understood that such modifications or corrections belong to the technical scope of the invention.

For example, a configuration according to an aspect of the invention can be applied to a configuration in which only one external circuit board common to a plurality of gate circuit boards and a plurality of source circuit boards is provided.

### INDUSTRIAL APPLICABILITY

An aspect of the invention can be applied to a display device in which drive circuits need to be satisfactorily protected from electrostatic discharge at a low cost and with a simple structure, or the like.

### DESCRIPTION OF THE REFERENCE SYMBOLS

3 Gate driver IC (driver element)

4 Source driver IC (driver element)

10 Liquid crystal display device (display device)

11 Gate driver driving common wire (driver driving common wire)

12 Display panel

12a Display surface

13 Gate driver circuit board (driver circuit board)

14, 14a Source driver circuit board (driver circuit board)

15 External circuit board

22 TFT substrate

31 Ground potential common wire

32 Source line

33 Gate line

66, 76 Grounding wire

1. A display device comprising:
a display panel configured to include a plurality of pixels and a pair of substrates facing each other;
driver elements configured to drive the plurality of pixels;
an external circuit board configured to control the driver elements; and
a plurality of driver circuit boards on which the driver elements are mounted and of one end is connected to the display panel,
wherein each of the plurality of driver circuit boards includes a grounding wire for setting a potential on a display surface side of the display panel to a ground potential around the driver elements and is connected to each of the pair of substrates.

2. The display device according to claim 1, the display device further comprising:
a driver driving common wire configured to electrically connect the driver elements of the plurality of driver circuit boards adjacent to each other and to supply a driving signal for the driver elements from the external circuit. board to the driver elements; and
a ground potential common wire configured to set the plurality of driver circuit boards adjacent to each other to a ground potential,
wherein the ground potential common wire includes the grounding wire.

3. The display device according to claim 2, wherein the ground potential common wire is grounded via the external circuit board.

4. The display device according to claim 2, wherein a plurality of source driver circuit boards for driving source lines are connected to one side of the display panel,
wherein a plurality of gate driver circuit boards for driving gate lines are connected to another side adjacent to the one side, and
wherein the driver driving common wire and the ground potential common wire are formed on the plurality of gate driver circuit boards and at least one of the plurality of source driver circuit boards connected to the external circuit board.

5. The display device according to claim 1, wherein the plurality of driver circuit boards are connected to a surface of one substrate of the pair of substrates of the display panel on which wires and terminals are formed and a surface of the other substrate of the pair of substrates which is opposite to the one substrate.
